(19) United States
(12) Patent Application Publication
(10) Pub. No.: US 2009/0222381 A1
(43) Pub. Date: Sep. 3, 2009

(54) PROCESS OF AND SYSTEM FOR FACILITATING CHECK PROCESSING AT POINT OF SALE AND ACCELERATED CREDIT FOR CHECK TRANSACTIONS

(76) Inventors: Frederick PURCHES, Coppell, TX (US); Paul BLACHOWICZ, Lantana, TX (US); James POTEET, Lewisville, TX (US); William C. MORGAN, Canton, GA (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/437,216

(22) Filed: May 7, 2009

Related U.S. Application Data
(63) Continuation-in-part of application No. 12/178,109, filed on Jul. 23, 2008.
Application No. 12/178,109 is a continuation-in-part of application No. 11/924,055, filed on Oct. 25, 2007.
(60) Provisional application No. 61/080,885, filed on Jul. 15, 2008.
(60) Provisional application No. 60/953,557, filed on Aug. 2, 2007.

(51) Int. Cl. G06Q 40/00

(52) U.S. Cl. 705/42; 705/35

(57) ABSTRACT

Process of and system for providing credit to a retailer by collecting checks from customers during financial transactions between the customers and the retailer, depositing by the retailer the collected checks into a safe located at the retailer facility, calculating the total monetary value of the checks that are deposited into the safe, and electronically transmitting a data file that identifies the calculated total monetary value of the deposited checks. Using the information in the transmitted data file, the retailer is credited by a bank or other financial institute with the total monetary value of the deposited checks. Crediting may be provided on a business day basis, and other features include imaging of the deposited checks, facilitating check processing using the image files of the checks, displaying the imaged checks on a display at the retailer during the financial transaction, depositing the checks into the same safe into which cash collected by the retailer is deposited, providing the checks within the safe in sealed cassettes, and printing an image of a collected check on a receipt that is provided to the customer. Other features also are described. The process and system advantageously make funds readily available and improves cash flow to retailers who take-in checks as part of their normal business operations.

### REFERENCE TO RELATED APPLICATIONS

This application claims priority to U.S. provisional patent application No. 61/080,885, filed Jul. 15, 2008. This application also is a continuation-in-part of U.S. patent application Ser. No. 12/178,109, filed Aug. 23, 2008, and is a continuation-in-part of U.S. patent application Ser. No. 11/924,055, filed Oct. 25, 2007, both of which claim priority to U.S. provisional patent application No. 60/953,557, filed Aug. 2, 2007. The disclosures of U.S. patent application Ser. Nos. 61/080,885, 12/178,109, 11/924,055 and 60/953,557 are incorporated herein by reference.

### FIELD OF THE INVENTION

The present invention relates to a process of and system for facilitating check processing at the point of sale and accelerated credit for check transactions and, more particularly, relates to the advancing of credit to commercial establishments based upon transactions entailing checks during the commercial establishments' normal business operations.

### BACKGROUND OF THE INVENTION

With today's fast-paced mentality, individuals and businesses expect instructions and tasks to be quickly acted upon in a wide-range of activities. For example, consumer transactions, via the Internet and at retail stores, are conducted substantially quicker today than years ago due to the use of more sophisticated technology. Similarly, banking transactions occur rapidly, such as the transfer of funds between accounts or electronic transfers to pay for goods or services. Many other examples also are available. There are, however, numerous areas that have not yet been substantially impacted by current technology and other advances. One such area entails the use of checks, as well as cash (i.e., coin and currency), in particular, the use of checks or cash by customers who purchase goods or services at retail establishments. In such types of transactions, while the speed at which the transactions themselves take place are relatively short (e.g., a few minutes), the speed at which the cash or the funds represented by the checks are subsequently used by the businesses that accepted the cash or checks is enormously slow. Cash needs to be picked up and processed by a cash handling service or deposited into a bank, and checks require processing. These processes often span several or more days. Hence, while modern developments have benefited businesses by enabling a multitude of tasks to be carried at remarkably fast rates, companies still currently are unable to make use of their cash and check collections until that cash and checks undergo generally several days of processing and handling.

### OBJECTS AND SUMMARY OF THE INVENTION

In view of the foregoing, it is an object of the present invention to provide retailers with the ability to expeditiously enjoy the benefit of their check and cash collections.

It is a further object of the present invention to provide a process that provides credit to retailers at the time of their check and cash collections.

It is another object of the present invention to enable retailers to enjoy the benefit of their check and cash collections independent of check processing and cash pickup schedules, cash vault cut-off windows and other schedules imposed by third parties.

To achieve the foregoing and other objects, the present invention entails a process of providing credit to a retailer that comprises collecting checks from customers during financial transactions between the customers and the retailer over a period of time, depositing the collected checks into a safe located at the retailer facility, calculating the total monetary value of the checks that are deposited into the safe, and electronically transmitting a data file that identifies the calculated total monetary value of the checks in order to enable for the retailer to be credited by a financial institution with the total monetary value of the deposited checks.

As an aspect of the present invention, the checks are imaged to produce image data when deposited into the safe. The image data is transmitted along with the data file to further facilitate crediting as well as subsequent check processing. Both sides of each check may be imaged.

As another aspect of the present invention, an image of the check is displayed on a display, such as monitor, disposed within or coupled to the safe in order to allow a clerk of the retailer to verify that the image is clear. If the image is not clear, then the check may be rescanned.

As a further aspect of the present invention, at the end of the financial transaction, the customer is provided with a printed receipt that includes a printed version of the check that the customer provided to the retailer.

As an additional aspect of the present invention, the identity of the payee and the monetary value of the check are electronically captured when the check is scanned. The check number and the routing/account number on the check also may be captured. The data file includes the captured information.

As yet another aspect of the present invention, the checks are transferred in the safe into a sealed cassette. The data file may also include the number of checks in the sealed cassette, the monetary value of each check, and the time and date of deposit into the safe of each check.

As yet a further aspect of the present invention, cash is collected from customers during retail transactions with the retailer. The collected cash also is deposited into the safe. The deposited cash may be transferred in the safe into a second sealed cassette. The data file also may identify the total amount of cash deposited into the cash.

As yet an additional aspect of the present invention, the retailer receives a credit as identified by the amount indicated in the transmitted data file. The credit may be applied before the checks and cash are physically withdrawn from the safe disposed at the retailer.

As a further aspect of the present invention, the process further includes transferring the checks to a check processing facility, verifying by the check processing facility the total monetary value of the checks to produce a verified amount, and adjusting the credit previously provided to the retailer based on differences, if any, between the verified amount and the calculated total monetary value of the checks deposited into the safe as identified in the electronically transmitted data file.

In accordance with another embodiment of the present invention, a process of providing credit to a retailer comprises collecting checks from customers over multiple business days, depositing the collected checks into a safe at the retailer, calculating, at the end of each business day, a total monetary value of the checks that were deposited into the safe on each business day, and electronically transmitting, at the end of each business day, a data file that identifies the calculated total monetary value of the checks deposited on the respective business day. The retailer is credit with its check deposits based on the information in the transmitted data files.

Each of the above-summarized aspects and features also are applicable to this embodiment. In addition, the check pickup schedule may be different, that is, not coincide with the end of business day of the retailer. As an additional aspect, the data file identifies the calculated total monetary value broken down by business day. The retailer also may be provided with a report identifying amounts of credit provided to the retailer on a business day basis.

In accordance with a further embodiment of the present invention, a process of providing credit to a retailer having multiple locations comprises collecting checks by the retailer at its multiple locations, depositing the checks collected at each location into a safe disposed at the respective location, calculating a total monetary value of the checks deposited at each location, electronically transmitting a data file for each location that identifies the calculated total monetary value of the checks deposited at each location, receiving by a facility all of the electronically transmitted data files, and arranging by the facility for the retailer to be provided by a financial institute with a total credit that corresponds to the sum of the total monetary values of the checks deposited into the safes at all of the locations as identified in the data files.

All aspects and features of the previously summarized embodiments also are applicable to this embodiment. In addition, for this embodiment, a further aspect is to provide the credit before the checks deposited into the safes at each location are physically removed from the safes. As a further aspect of this embodiment, different locations of the retailer transmit the data files at different times.

In accordance with yet a further embodiment of the present invention, the invention is embodied as an electronic system that includes a safe disposed at the retailer location, where the safe has stored therein checks that are collected from customers over a period of time. The safe is designed to calculate the total monetary value of the deposited checks and to electronically transmit a data file that identifies the calculated total monetary value of the deposited checks in order to enable for the retailer to be credited with the value of the deposited checks.

The various previously summarized features and aspects, as well as method embodiments, may also be applied to the system embodiment of the present invention. Further, the system embodiment may entail multiple retailer locations as previously mentioned. Still further, the safe may include an imager (coupled to or within the safe) for electronically imaging each check deposited into the safe, a display (e.g., monitor) (coupled to or within the safe) for displaying the imaged check in order to allow a clerk to verify (e.g., via a keyboard or other input device) that the scanned image is clear, and a printer (coupled to or within the safe) for printing a receipt that contains a printed image of the check.

Various other objects, advantages and features of the present invention will become readily apparent to those of ordinary skill in the art from the following detailed description of the invention.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a block diagram that shows multiple entities that may be involved in a collection process that embodies the present invention;

FIG. 2 is a schematic flow diagram that shows in general terms the process for advancing credit to retailers in accordance with the present invention;

FIG. 3 shows the Brink's CompuSafe 4000® safe, which may be employed in the present invention; and

FIG. 4 is a diagram useful for describing various features of the present invention.

### DETAILED DESCRIPTION OF THE PRESENT INVENTION

The present invention takes the store-level check handling process into the electronic age. As will be described, the present invention improves check processing, expedites funds availability, improves cash flow and provides other features and benefits to commercial establishments that routinely accept checks during the course of their business day.

The present invention entails imaging customers' personal and business checks at the point of sale (e.g., retail establishment) and facilitates advance bank credit to the retail establishment in the amount of the financial transactions paid by check. As used herein, the “point of sale” or retail establishment means the physical location at which a check (e.g., personal check) is supplied from an individual, such as a customer, generally in exchange for goods and/or services. The retail establishment can be an entity that sells, leases or otherwise offers goods, such as a grocery store, clothing store, gas station, etc., or an entity that sells or otherwise provides services, such as a transportation provider (e.g., an airline, bus company, etc.), a spa/gymnasium, a health care provider, a law office, etc., or an entity that offers, leases or otherwise provides both goods and services. At the retail establishment (sometimes called “retailer” herein for convenience), an individual typically pays for goods and/or services using cash (i.e., paper currency, coins), a credit card, a debit card, or by check. Many retailers, however, do not accept one or more of these types of payment for various reasons, such as inconvenience, high transaction processing fees, delayed processing, risk of default (e.g., a “bounced” check) or other reason. In fact, for multiple reasons, many retailers do not accept payment by check. Other retailers discourage payment by check or impose restrictions on check usage, such as, for example, by accepting only “in-state” checks. As herein described, the present invention provides a process/system that eliminates or minimizes various shortcomings of retail check handling, thereby enabling retailers improved convenience, better money management and other benefits when accepting checks for payment of goods or services

The term “check” (spelled “cheque” in various countries) as used herein refers to the common understanding of what a check is. More formally, a check is a negotiable instrument that authorizes a financial institution, such as a bank, to transfer to a specified entity a designated amount of money from an account held at that financial institution. There are different types of checks. The most common type of check is an “order” check, which is payable only to the named payee. Other types of checks (or sub-types of order checks) include a bearer check (e.g., made payable to “bearer” or “cash”), a bank check, a certified check, a traveller's check, a money order, a postal order, etc. As provided herein, a “check” may be any of these types of negotiable instruments.

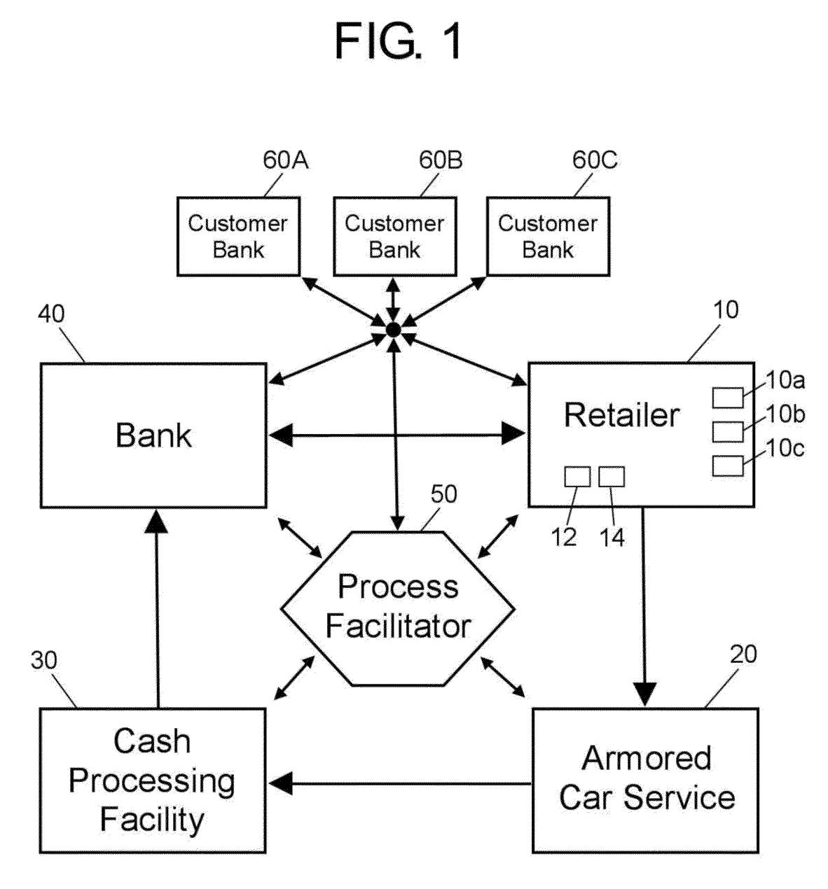

Referring now to the drawings, FIG. 1 thereof is a block diagram that shows multiple entities that may be involved in financial collection processes that embody the present invention. The entities shown include retailer 10, armored car service provider 20, cash processing facility 30, a bank 40, process facilitator 50, and customers' banks 60A, 60B and 60C. Additional entities may also be involved to assist with one or more entities with its respective functions. In addition, a process embodying the present invention may entail fewer entities than that shown in FIG. 1. Various operations of retailer 10 initially are discussed. The functions of the other entities shown in FIG. 1 are then discussed.

Prior to describing the inventive process/system, it is important to note that typical check processing employed today entails a lag from when a check initially is received by a retailer to when that check is initially processed, and an even greater lag from when that check is received by the retailer to when the funds represented by the check become available for use by that retailer. For large retailers that accept checks, the checks collected on a daily basis may total in the tens of thousands of dollars, perhaps more. These funds are unusable, and do not bear interest, until the checks are deposited and the financial institutions holding the accounts drawn upon transfer the funds to the retailer's bank account. Even for businesses that receive relatively few checks during each business day, the cumulative affect, for example, over a 12-month period of not immediately enjoying use of the funds result in a measurable and meaningful impact on such businesses.

As described herein, the present invention provides for a novel process/system for processing checks at the retailer's place of business (i.e., at the point of sale) and advancing credit to retailers in amounts that correspond to the funds represented by checks received by those retailers during their normal business operations. By advancing such credit, retailers are able to enjoy the benefit of the value of the accepted checks almost immediately, thereby enabling retailers to immediately bear interest on such funds or to otherwise immediately utilize such funds in manners suitable for the retailers' successful operations.

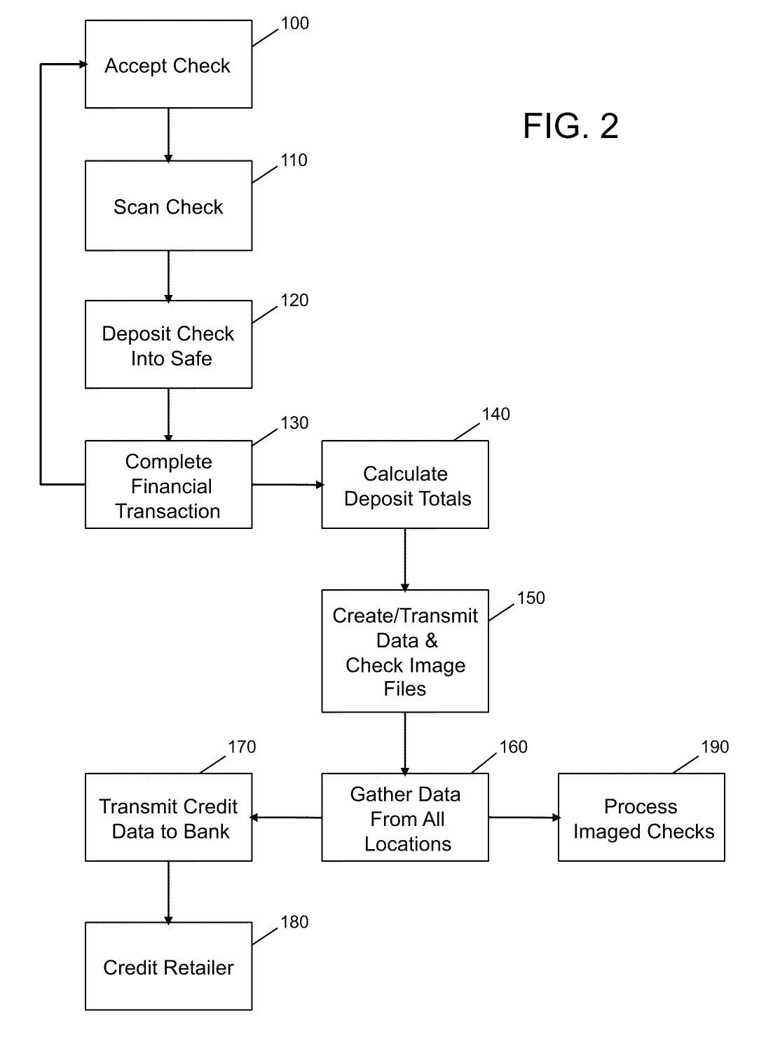

FIG. 2 of the drawings is a schematic flow diagram that shows in general terms the check handling process of the present invention. Initially, during a financial transaction, a retailer 10 accepts a check from, for example, a customer in payment for goods and/or services, as shown as step 100. As one example, a grocery store sales person (or “clerk”) accepts from a customer a personal check for twenty-five dollars, made out to the grocery store retailer, in exchange for a certain amount of groceries that are being purchased by that customer. Then, during the financial transaction, the clerk deposits the check into an imaging device that images (or “scans”) the front of the check to produce an image file (also called “check image file”) representing the front of the check, as shown as step 110. The image file may be stored within the imaging device or elsewhere. The imaging device is represented as imager 12 in FIG. 1. The check, upon being imaged, preferably is stored (or “deposited”) in a secure storage compartment, as shown as step 120 in FIG. 2.

In particular versions of the present invention, the check is both imaged and deposited into an electronic cash register, electronic safe, electronic drop safe, or other electronic device (hereinafter, collectively, “safe”) that includes both an imaging device and a suitable secure storage area for safely storing each check that is imaged. This “safe” is represented as safe 14 in FIG. 1. The imaging device and storage area may be integral with the safe, that is, be components disposed within the body of the safe. The imaging device and storage area may be located ancillary to the safe. As another variation, the imaging device may be external to the safe and the storage area is disposed within the safe. In any event, the check may be both imaged and deposited into the safe during the transaction with the customer or after the transaction is completed.

The safe also preferably has the capability to recognize the denomination of currency (i.e., cash) that is deposited into it and the capability to accumulate cash deposit totals over a predetermined period of time, such as a business day. In such a preferred safe, cash is inserted into bill acceptors that identify the deposited currency, and checks are inserted into a separate acceptor (“check acceptor”) that, in turn, images the inserted check and subsequently stores it. The safe also preferably has the capability to capture from the scanned check various information on the check including, for example, the payee, check number, date, amount of currency, and routing/account number.

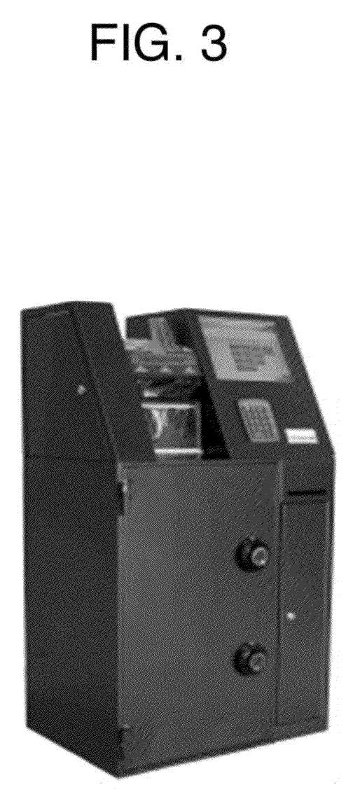

As one example, a suitable safe that may be employed with the herein-described process of the present invention is the Brink's CompuSafe 4000® safe that is additionally fitted with an imaging scanner. The Brink's CompuSafe 4000® safe is shown in FIG. 3 of the drawings. Various features of the Brink's CompuSafe 4000® safe are discussed in U.S. Pat. Nos. 5,695,038; 5,975,275; and 5,944,163, which are assigned to the assignee of the present application and are incorporated herein by reference. In the Brink's CompuSafe 4000® safe and as discussed in the foregoing identified patents, bill acceptors within the safe accept the cash and transfer the accepted cash into sealed cassettes disposed within the safe, and a processor produces deposit reports that identify the contents of the sealed cassettes. The deposit reports specifically identify the stored contents by denomination, the total cash deposit, and other information.

When fitted with a suitable imaging device and suitably programmed, the Brink's CompuSafe 4000® safe, as an example, accepts a check, images one side of the check (or both sides of the check in another version) to produce an image file, stores the image file within internal memory, and transfers the imaged check into a sealed cassette disposed within the safe. The processor within the safe, in a particular version, is suitably programmed to include within its deposit reports information that also identifies the total value of all of the checks stored within the safe (called herein “check deposit total”). The deposit reports may also include additional information about the stored checks, including identifying the number of checks that are stored, the respective monetary amount of each of those checks, and the date/time each check was deposited.

Although the functions of the Brink's CompuSafe 4000® safe are particularly described herein, and the Brink's CompuSafe 4000® safe fitted with an imaging device having the functions and features as described above is well-suited for carrying out various processes of the present invention, other electronic devices having such functions may be employed. For example, Brink's CompuSafe® 3000 Series, fitted with an imaging device, also may be employed. Other electronic devices, including those of other companies, may be utilized. It is noted that the Brink's name and the CompuSafe® mark are registered trademarks of Brink's Network, Inc., the assignee of the present application.

Returning to the flow chart shown in FIG. 2, the financial transaction being carried out is completed, as shown as step 130. During such completion, various activities may be implemented, including displaying the scanned image on a display device and verifying by the clerk that the scanned image is clear and easily readable. The display device may be incorporated within the safe, be incorporated within an attached device, or be a separate device altogether. At the end of the transaction, a receipt preferably is printed (e.g., by an attached printer or a printing device integrated within the safe) that includes information concerning the financial transaction and that also includes a printed image of the scanned check. The clerk provides the printed receipt to the customer and the transaction is concluded.

During the course of the retailer's business day, additional financial transactions are processed, as represented by the arrow extending from step 130 to step 100 in FIG. 2. Additional checks may be collected and the collected checks are imaged and deposited into the retailer's safe in the manner described above. In cases in which customers provide cash as payment for goods or services, the retailer deposits the collected cash into a suitable cash-receiving device, which may be the same safe into which checks are deposited, that is, the safe described above (transactions involving cash not shown in FIG. 2). Preferably, the safe maintains both the cash deposit totals and the check deposit totals during the course of the business day.

Each of the variations of the present invention, as described above, have been described in the context of a retailer that employs a single device, such as an electronic drop safe that images each check, stores the generated image file, and stores (deposits) the actual check within a storage area. Cash also may be deposited into that same device or a separate device, as already discussed. A retailer may also employ multiple safes having the above-described features that are disposed within a single location or multiple safes that are disposed at multiple locations. No matter the case, checks are imaged and deposited (and similarly, cash is deposited) within each safe, and preferably the value of each deposited check (and deposited cash) is maintained by each safe.

At a certain time of each day, preferably (although not necessarily) at the close of the retailer's business day, the deposit totals of each of the retailer's safes are calculated, as shown as step 140 in FIG. 2. In the above grocery store example, if the grocery store had a single location with two safes, the total deposit amounts of the two safes are obtained to identify both the total monetary value of the checks that have been collected and the total amount of cash that have been collected by that retailer during the course of the business day. For retailers with multiple locations, the total deposit amounts of all safes within all of the retailer's locations are obtained. In a variation, the total deposit amounts of the safes within a select number of the retailer's locations are obtained. For example, a retailer with stores in different parts of a country (e.g., on both the east coast and west coast of the United States), or in different countries, may desire to employ the process of the present invention separately for its stores in such different areas.

In any of the examples provided above, it is appreciated that the monetary value of the checks collected and the amount of cash collected by a retailer generally is a function of the size of the retailer, the number of locations (e.g., retail stores) of the retailer, the types of goods/services that are provided, the relative amount of use of credit/debit cards by the retailer's customers, and other factors. As illustrated herein, the inventive process for advancing credit to retailers may be applied to retailers of any size who accept payment by check (and/or cash).

As mentioned above, deposit totals are calculated at a certain time of each day. The time of day may be defined by the retailer's standard time of close of business day, or the respective store's end of business day. The time may be manually identified each day. For example, a retailer's employee may manually instruct the safe to “close-out” the business day. Further, another time may be selected that does not coincide with the retailer's business day. In a further variation, deposit totals are calculated every other day, every third day, or at other periods of time. In yet another variation, deposit totals are calculated on an intraday basis, that is, deposit totals are calculated multiple times in a given day, whereby the herein-described process is carried out multiple times on that day. In any of these cases, deposit totals are calculated (or calculated/maintained by the safes during the course of the retailer's operations) at a given point of time. For convenience, and without limiting the description to calculating the deposit totals at the actual end of a retailer's business day or calendar day, the point of time deposit totals are calculated is referred to hereinafter generically as the “end of day.”

Upon calculating the deposit totals at the end of day, the safe at one retailer location (e.g., 10a shown in FIG. 1) creates a data file that contains the deposit totals at that location and electronically transmits the created data file and the stored check image files to a process facilitator, such as process facilitator 50 shown in FIG. 1. Data file creation and transmission of the data and check image files are represented as step 150 in FIG. 2. Similarly, each safe at each of the retailer's other locations (e.g., 10b, 10c) creates a respective data file that contains the deposit totals at that respective location and transmits the data file and the check image files stored at that respective location to process facilitator 50.

In a variation of that represented by step 150 as described above, the retailer's safe (or safes for multiple locations) transmits data and the stored check image files, either once at the end of day or periodically throughout the day, to another system within or controlled by retailer 10, such as a computer system, to enable that other system to create the data file, which is then transmitted along with the check image files to process facilitator 50. The data and check image files may be transmitted to a temporary electronic storage medium located at retailer 10, or may be transmitted securely, for example, to retailer 10's main processing facility (e.g., via an intranet, via a website, etc.). Data and/or check image files may be transmitted multiple times and periodically within, for example, each business day from the retailer's safe, either directly or indirectly, to a system within or controlled by retailer 10 or to a system within or controlled by process facilitator 50.

The safe (or safes for multiple locations) within retailer 10 transmits the total monetary value of the deposited checks, the value of each check, the check image files, as well as the total amount of cash that has been collected, since the safe's previous transmission. Then, the system to which all of the transmissions are sent calculates, based on all of the transmissions, the amounts of the deposit totals for that safe within retailer 10. In yet another variation, one or more computing systems controlled by retailer 10 or, alternatively, controlled by process facilitator 50 remotely access the retailer's safes, pulling deposit totals, check value data, check image files and other data at predetermined times.

Process facilitator 50 includes a suitably programmed computing system (or systems) that receives the electronically transmitted files. Transmission may occur in any known manner, such as via the Internet, telephone system, a private communications network or other suitable manner. Preferably, transmissions are encrypted to ensure proper security and privacy. Since electronic data transmission and encryption, as well as the hardware/software that carry out such transmission and encryption, are well known, further description thereof is omitted herein except where necessary for an understanding of the present invention.

The computing system within process facilitator 50 gathers and accumulates the check and cash deposit totals, and the check image files of all locations of retailer 10 (e.g., 10a, 10b, 10c, etc.) based on the information contained in the files transmitted from each location. Process facilitator 50 processes each transmitted file when received or at preset times. Upon receiving transmissions from all locations of retailer 10, process facilitator 50 calculates the total check and cash deposits for all locations. The gathering of the data and check image files, and calculating (accumulating) of the total check and cash deposits for retailer 10 for that particular business day/time period is represented as step 160 in FIG. 2.

Upon calculating the check and cash deposit totals for all locations of retailer 10, for the relevant time period, process facilitator 50 electronically transmits an encrypted data file containing the total deposit information, along with retailer 10 identification information, (also called “credit data” herein) to bank 40, as represented as step 170 in FIG. 2. Bank 40 (or other type of financial institute, collectively referred to herein as a “bank”) processes the transmitted credit data (e.g., performs identity verification and other security handling as is well known) and credits the bank account of retailer 10 with the identified total check and cash deposit, as represented as step 180 in FIG. 2. In yet a variation, the above-discussed files are transmitted from retailer 10 to bank 40, which in turn carries out the herein-described functions of process facilitator 50 and then credits retailer 10 based upon the ascertained total check and cash deposit. In general, bank 40 and process facilitator 50 preferably enter into a contractual relationship to facilitate the herein-described crediting to retailer 10 of funds in the amount of the total deposits of retailer 10.

In addition to facilitating advance credit to retailers for their check as well as cash deposits, in a particularly preferred embodiment of the present invention, each of the deposited checks are also processed by process facilitator 50 by utilizing the check image files that have been transmitted from retailer 10. As represented by step 190 in FIG. 2, process facilitator 50 carries out electronic processing of the imaged checks (i.e., the check image files). In such preferred embodiment, process facilitator implements all processing of the imaged checks necessary to draw the funds from the accounts held by the customers (e.g., within customer banks 60A, 60B, 60C shown in FIG. 1). Process facilitator may carry out any industry accepted electronic conversion process, including, as an example only, Back Office Conversion (BAC) wherein accepted checks are converted to ACH debits. Since the requirements and operations to process a check are well known, a description thereof is not provided except where necessary for an understanding of the present invention. After the imaged checks are processed, the actual checks collected by retailer 10 may be destroyed by the retailer (e.g., 7 business days after receipt) or delivered to another entity for storage or destruction thereof. Similarly, the check image files stored by retailer 10 may be deleted after a preset period of time after collection or processing (e.g., 10 business days after receipt). In variations of the invention that do not electronically process the check image files to draw funds from the customer accounts, any legally acceptable manner of check handling may be employed, including as an example depositing of a customer check within the bank holding the account (i.e., On-Us check). Other suitable check handling processes may be employed.

As already mentioned, retailer 10 may have multiple locations (e.g., 10a, 10b, 10c), wherein a safe (or other device) at each location calculates the check and cash deposit totals at the respective location at the identified end of day and thereafter creates and transmits to process facilitator 50 a respective data file with the deposit total information (along with appropriate retailer location identification data and the check image files). The “end of day” for each location may occur at the same time of day or may occur at different times of day. For retailers with a relatively large number of stores located, for example, throughout a country or region, different locations may likely have different “end of day” times. For example, certain retailer locations may have different times of operation, may have the same times of operation but operate in different time zones, or a combination of the two.

The herein-described inventive process for advancing credit for checks, as well as cash collections, beneficially is well suited for large-scale retailers having many locations with different times of operation. Safes at each location accumulate the check and cash totals for the respective location and at a designated “end of day” for such location create a data file that contains the deposit totals for that location. Over the course of, for example, a 24 hour time period, process facilitator 50 receives from the retailer's different locations these data files, as well as the check image files, and calculates a deposit total for all locations and transmits this total to the retailer's bank, which in turn credits the retailer's bank account with such total.

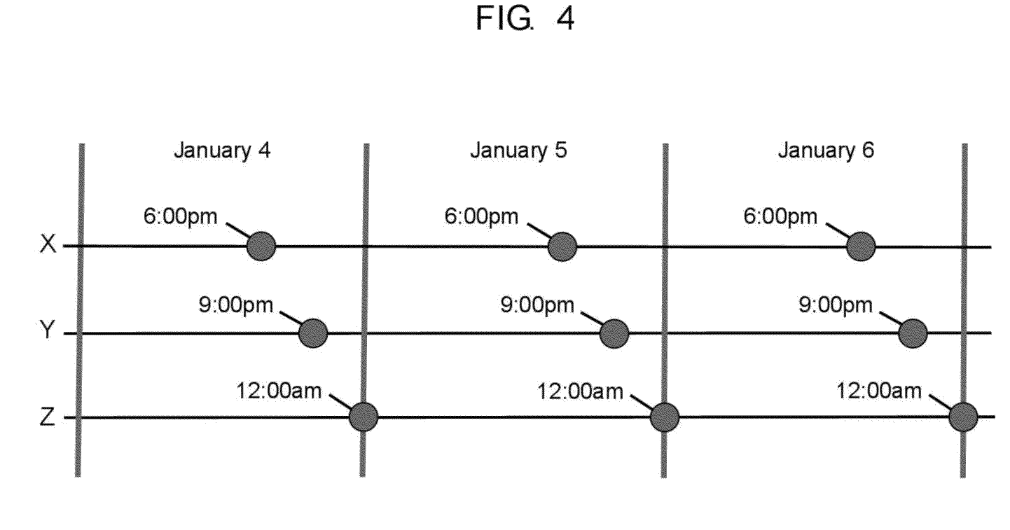

FIG. 4 is a diagram that is used to explain the operation of the present invention entailing a retailer with multiple locations and where different locations have different ends of day. For example, and referring to FIG. 4, an exemplary retailer has a number of store locations “X” that have an end of day at 6:00 pm (each such location identified herein as an “X location”). The exemplary retailer also has a number of other store locations “Y” that have an end of day at 9:00 pm (each such location identified herein as a “Y location”). Finally, the exemplary retailer further has a number of store locations “Z” that have an end of day at 12:00 am (i.e., midnight) (each such location identified herein as a “Z location”). In accordance with the present invention, on a given business day, such as January 5, a safe (or safes) at each X location ascertains at the end of day of 6:00 pm the amount of checks and cash collected between 6:00 pm of the previous business day of January 4 and 6:00 pm of the current business day of January 5. Thereafter, the ascertained amount of checks and cash collected during this time period is identified within a data file that is transmitted, along with the check image files, to a process facilitator. Similarly, on that same day, that is, on January 5, a safe at each Y location ascertains at 9:00 pm (i.e., the “end of day” of each Y location) the total amount of checks and cash that were collected at that location between 9:00 pm of the previous business day of January 4 and 9:00 pm of that day, and such total amount is transmitted to the process facilitator. A safe at each Z location ascertains at 12:00 am (i.e., the “end of day” of each Z location) on January 6 the total amount of checks and cash that were collected at that location between 12:00 am of the previous business day of January 5 and 12:00 am of that business day of January 6, and the ascertained total amount is transmitted to the process facilitator. Process facilitator then sums the reported amounts and arranges for a bank to credit the retailer with the summed amount.

As illustrated in the above example, the retailer may be provided with a credit each day based upon check and cash collections that occur over different periods of time within the retailer's different store locations. Each end of day may represent the time at which a respective retailer location closes. Or, one or more locations of the retailer may close at a time that differs from the respective location's end of day. Still yet, one or more locations of the retailer may be open 24 hours, that is, not be closed at all. In such cases, a credit may be provided for checks and cash collected at one location at the end of that business day, while a credit may be provided for checks and cash collected at another location at the end of the next business day. For example, cash and checks collected at 8:00 pm at a location Y on January 5 will be credited to the retailer at the end of that business day (i.e., at the end of January 5). However, checks and cash collected at 8:00 pm at a location X on January 5 will not be credited to the retailer until the end of the next business day, that is, on January 6. If this is not desired, then the “end of day” of particular locations may be modified. But, in any event, it is seen that the herein-described inventive process for advancing credit for check and cash collections is sufficiently flexible to accommodate retailer locations that have different operating schedules, that operate in different time zones, that perhaps have different cash flow needs, and/or that may have or that desire to have different end of day times. In each of these cases, the present invention enables retailers to receive credit on a basis that is more closely aligned with the volume of their check and cash collections, and that is not dictated by the schedule that the physical checks and cash are picked-up for deposit into a bank or other third party schedule, as further discussed below.

As described herein, process facilitator 50 receives data files that collectively identify the collections (checks and cash) at all of the retailer's locations and thereafter ascertains the total credit to be provided to the retailer (e.g., for that business day). In a variation, process facilitator 50 may impose a predefined cut-off time by which files from all locations of the retailer must be received. Then, at such cut-off time, process facilitator 50 calculates the total check and cash deposits for those locations that have transmitted the respective files and transmits such total deposit information to bank 40 for subsequent credit to retailer 10 in the amount indicated. In such case, advance credit still is provided even if all of the retailer's locations are unable, for whatever reason, to transmit the files to process facilitator 50. As one example, technical difficulties at a location may prevent or otherwise delay proper processing at such location. No matter the case, the present invention provides advance credit of all, or at least a part, of a retailer's check and cash deposits. If only a part of the retailer's deposits are credited, the non-reported deposits may be credited at a later time, such as at the end of the next “end of day.”

As mentioned above, the herein-described inventive process for advancing credit for check and cash collections expedites funds availability to a retailer. As described above, the “end of day” occurs at a certain point in time. In such case, the retailer is credited once each day for the checks and cash that are collected generally during the preceding 24-hour period. The herein-described process, however, may be carried out multiple times a day, such as at every 12-hour period. Conversely, the process may be carried out less than once per day, such as every other day. For example, smaller retailers (e.g., with only a single location or a few locations) may accumulate relatively few checks (or checks of small value) and/or little cash each day and, thus, carrying out the process every two or three days may be sufficient for such smaller retailers.

In yet another variation, a retailer with multiple locations may, in a sense, be treated as multiple retailers. For example, credit may be provided after retailer locations in one part of the country report their deposit totals and then, separately, credit is provided after the other retailer locations report their deposit totals. Such a subdivision may be based on geographic criteria or other basis.

In each of the variations described herein, a retailer is credited with the total deposits accumulated over a period of time (e.g., each business day) based on deposit totals as reported by each of the retailer's locations. Accordingly, the present invention enables a retailer to enjoy the benefit of the value of the accepted checks and its cash receipts almost immediately upon collecting those checks and cash from its customers. The actual checks and cash, however, still remain at the retailer location(s) even after the retailer is credited with those receipts. Co-pending application Ser. No. 12/178,109, filed Aug. 23, 2008, entitled Process of and System for Facilitating Cash Collections Deposits and Deposit Tracking, owned by the assignee of the present application and incorporated herein by reference, is directed to facilitating novel cash collections deposits (i.e., handling of the physical cash itself) and deposit tracking and such process or portions of such process may employed in conjunction with the herein-described inventive process for advancing credit for check and cash collections. Regardless of whether the invention described in co-pending application Ser. No. 12/178,109 is employed, generally an armored car service provider 20 (FIG. 1) picks up from retailer 10 the cash deposits and possibly the collected checks at preset periods of time (e.g., daily, twice daily, every other day, weekly, etc.) and transports the picked up deposits to a processing facility (e.g., cash processing facility 30 shown in FIG. 1) for further handling. As used herein, an armored car service refers to any entity that picks up the cash deposits and/or the collected checks, and includes courier or message services (including governmental and private postal delivery services) that employ or do not employ armored cars. Still further, the cash deposits and the collected checks may be delivered together or separately to the same processing facility or may be delivered to different processing facilities. For example, cash deposits may be picked up by an armored car service that, in turn, transports the picked up cash to a cash processing facility and, separately, the collected checks are picked up by a courier service and delivered to a bank (or other financial or non-financial institute). As described herein, any reference to the pickup or delivery of cash deposits and collected checks shall include any of the above-identified pickup/delivery variations.

In accordance with the present invention, crediting as described herein does not need to coincide with a business day. In addition, and as mentioned above, a retailer is credited with its check and cash collections in advance of, sometimes several days or more prior to, when the checks are processed, when the monetary funds represented by the checks become available for use by the retailer and/or when the actual cash reaches the bank. As a particularly beneficial feature of the present invention, a retailer can be provided with credit for its check and cash collections on a more frequent basis than when those collections are picked-up, for example, by an armored car service and/or when the checks are delivered to a check processing facility (e.g., bank or other facility). For example, for relatively small retailers, a retailer's deposits are picked up every other day, or every third day, or based on a cash volume basis, or based on another basis, whereupon that retailer may be credited in accordance with the present invention with its check and cash collections on a daily basis. In such case, a retailer obtains the benefit of daily credit without incurring the expense of daily pick-up. Thus, the present invention disassociates the time and frequency of a retailer's pickup schedule from the time and frequency of when that retailer is credited for its collections. More specifically, a retailer is able to enjoy the benefit of its collections on a basis that is independent of when those collections are actually picked up, when the checks are processed, when funds represented by the checks become available for use by the retailer, when the cash is processed (e.g., by a third party cash processing facility), or when the cash is deposited into a bank.

As described, retailer 10 is credited with its collections based on a schedule that is independent from the schedule at which collected cash and/or checks are delivered to processing facilities. For example, armored car service provider 20 picks up from retailer 10 the collections at preset periods of time (e.g., daily, twice daily, every other day, weekly, etc.) and transports the collections, preferably stored within secured deposit bags to a processing facility (e.g., cash processing facility 30 shown in FIG. 1) for further handling. Alternatively, a retailer may manually schedule a pickup by armored car service provider 20. Regardless of whether pickups are pre-scheduled or manually scheduled, the retailer is provided with advance credit for its check and cash collections shortly after the retailer receives the checks and cash.

Cash processing facility 30, upon receiving the deposit bags (i.e., the collected cash and/or checks), verifies the contents of the deposit bags. Such verification may occur at any time after receipt, but it need not occur on the same day that the deposit bags are received. For example, verification may occur on the next business (or calendar) day or even on a future date. In any event, verification entails identifying the deposit bags, opening the deposit bags, removing the cash/checks contained within the deposit bags and counting the cash and/or check values to verify that the actual cash and/or check values content coincides with the deposit detail information supplied by retailer 10 (called “verification” herein).

During verification, if cash processing facility 30 discovers an overage or shortage in the amount of cash and/or the value of the checks contained in the deposit bag(s) as compared to the deposit amounts previously reported by retailer 10 and previously credited to retailer 10 in accordance with the present invention, such overage/shortage is communicated to bank 40 to correct the amount of credit previously provided to retailer 10.

Finally, the cash is transferred to bank 40. Cash processing facility 30 (or bank 40 or process facilitator 50) transmits to retailer 10 a report (e.g., an electronic file) that identifies actual cash and check deposit information for retailer 10 to utilize for reconciliation, tax and other purposes. The report may be an intraday report, a daily report, a weekly report, a monthly report, etc.

In accordance with a particularly beneficial feature of the present invention, the information transmitted to retailer 10 includes an accounting of the particular business day or business days to which the credit is applied, including a credit breakdown by business day. In such instance, if a deposit amount identified in a data file transmitted from one of the retailer's safes corresponds to checks and cash collected over multiple business days, then the data file preferably includes a breakdown by business day of the respective amounts collected during each of those business days. For example, with reference again to FIG. 4, a location “X” has an end of day at 6:00 pm as shown, but is open 24 hours a day. If, for example, the retailer's business day coincides with a calendar day, then at 6:00 pm on January 5, a data file is created (e.g., by the safe) and then transmitted for that location that identifies the total amount (i.e., checks and cash) collected from between 6:00 pm of January 4 through 12:00 am of January 5, and separately identifies the total amount collected from 12:00 am through 6:00 pm of January 5. With such transmitted information, the total amount of credit provided to the retailer is applied on a business day basis. Thereafter, at the next end of day at 6:00 pm on January 6, another data file is created and transmitted for that location that identifies the total amount collected from between 6:00 pm of January 5 through 12:00 am of January 6, and separately identifies the total amount collected from 12:00 am through 6:00 pm of January 6, and credit is provided accordingly. From the foregoing example, the total amount of credit provided for the business day of January 5 is based on a first transmission (at or shortly after 6:00 pm on January 5) that identifies a partial collection on January 5 (i.e., cash and checks collected from 12:00 am through 6:00 pm) and a second transmission (at or shortly after 6:00 pm on January 6) that identifies another partial collection on January 5 (i.e., cash and checks collected from 6:00 pm through 11:59 pm). Accordingly, credit reports are provided to the retailer that identify credit provided on a business day basis, without the need for a single transmission (from the retailer) to identify collections over each entire, complete business day. U.S. Pat. Nos. 5,695,038; 5,975,275; and 5,944,163, previously identified, discuss business day reporting in the context of producing reports that identify collections broken out by each partial business day and each full business day. Thus, safes with such capability, such as the Brink's CompuSafe 4000® safe, may be employed within the present invention to provide the above-described additional feature of allocating and reporting credit on a business day basis.

The features and variations described herein may be applied in instances where a retailer's business day coincides with its end of day, or where the business day does not coincide with the end of day, where the business day coincides or does not coincide with a calendar day, and/or where the end of day coincides or does not coincide with the calendar day.

In addition to the foregoing information provided to the retailer, the retailer additionally may access the system/database of process facilitator 50 to track the retailer's deposits, produce reports, view historical information including exceptions and variances, and receive statistical information including total expected daily deposits.

For retailers with multiple locations, various data and reports are producible on a store-by-store basis, if desired, to enable individual stores to access their own deposit/credit activity. Moreover, credit and deposit report data are available to the retailer on a store-by-store, select group of stores, or entity-wide basis, immediately or nearly immediately after collection and/or crediting the retailer with such collection.

As the foregoing-description sets forth, the present invention expedites funds availability, including improved cash flow and provides other features and benefits to commercial establishments who take-in checks and cash as part of their normal business operations. In particular, advance credit is provided to retailers in novel manners that enable retailers to enjoy the benefit of check and cash collections almost immediately, without having to wait for those checks to be deposited or otherwise delivered to a processing facility or to wait for collections to be picked-up by armored car service providers, and then processed by third party cash processing facilities and then eventually deposited into and/or otherwise processed by a bank. Such post-collection activity commonly takes several days, if not more, during which time retailers historically are not able to utilize the funds that have been collected. Retailers, both large and small, are disadvantaged by this lag period. The present invention, however, enables retailers to enjoy the benefit of their collections shortly after the checks and cash are received. These benefits are realized regardless of pickup schedules, vault cut-off windows and other schedules controlled by third parties.

Having described the present invention including various features and variations thereof, it is intended that the appended claims be interpreted as including the embodiments described herein, the alternatives mentioned above, and all equivalents thereto.

What is claimed is:

1. A process of providing credit to a retailer for collections occurring during financial transactions with the retailer, comprising the steps of:
collecting checks from customers by a retailer during financial transactions between the customers and the retailer over a period of time;
depositing the collected checks into at least one safe disposed at the retailer;
calculating, at a designated time, a total monetary value of the checks deposited into the safe over said period of time; and
electronically transmitting at least one data file having data identifying the calculated total monetary value of the checks over said period of time to enable for the crediting of the retailer by a financial institute with the identified calculated total monetary value of the checks.

2. The process of claim 1, further comprising electronically imaging each of the checks deposited into the safe to produce image data; and wherein said at least one data file includes the image data.

3. The process of claim 2, wherein electronically imaging of each check is carried out during the respective financial transaction in which the respective check is collected by the retailer from a customer.

4. The process of claim 3, further comprising, during each financial transaction during which a check is collected from a customer by the retailer, displaying on a display disposed in or coupled to the safe an image of the electronically imaged check as represented by the image data; and receiving a verification from a clerk of the retailer indicating that the image on the display is readable.

5. The process of claim 3, further comprising providing to the customer a printed receipt containing a printed image of the electronically imaged check at an end of a financial transaction in which a check is collected from the customer by the retailer.

6. The process of claim 2, wherein electronically imaging of each check includes electronically capturing from the imaged check an identity of a payee on the check and a monetary value of the check; and said at least one data file includes data identifying the captured identity of the payee and the monetary value of the imaged check.

7. The process of claim 6, wherein electronically capturing includes electronically capturing a check number on the check, a date identified on the check and a routing/account number on the check; and said at least one data file includes data identifying the captured check number, date and the routing/account number.

8. The process of claim 1, further comprising electronically imaging both sides of each of the checks deposited into the safe to produce image data; and wherein said at least one data file includes the image data.

9. The process of claim 1, wherein the step of depositing the collected checks comprises electronically imaging each of the checks during deposit into the safe, producing image data representing each imaged check, and transferring the imaged checks into a sealed cassette disposed within the safe, said at least one data file including the image data of each imaged check.

10. The process of claim 9, wherein said at least one data file includes data identifying a number of checks transferred into the sealed cassette disposed within the safe, a monetary value of each of the checks transferred into the sealed cassette, and a respective date and time of deposit of each of the checks into the safe.

11. The process of claim 9, further comprising collecting cash from customers by the retailer during other financial transactions over said period of time; and depositing the collected cash into a second sealed cassette disposed within the safe into which the collected checks are deposited.

12. The process of claim 11, further comprising calculating a total monetary amount of the cash deposited into the safe over said period of time; and wherein said at least one data file includes data identifying the calculated total monetary amount of the cash.

13. The process of claim 1, further comprising the steps of receiving by a facility the electronically transmitted data file; and arranging by the facility for the retailer to be credited by the financial institute with the calculated total monetary value of the checks collected by the retailer as identified in the data file.

14. The process of claim 13, wherein arranging by the facility for the retailer to be credited by the financial institute occurs before the checks deposited into the safe are physically removed from the safe.

15. The process of claim 13, further comprising the steps of transferring the checks deposited into the safe to a check processing facility, verifying by the check processing facility the total monetary value of the checks to produce a verified amount; and adjusting the credit previously provided to the retailer based on differences, if any, between the verified amount and the calculated total monetary value of the checks deposited into the safe as identified in the electronically transmitted data file.

16. A process of providing credit to a retailer for collections occurring during financial transactions with the retailer, comprising the steps of:
collecting checks from customers by a retailer during financial transactions between the customers and the retailer over a plurality of business days;
depositing the collected checks into a safe disposed at the retailer;
calculating, at an end of day for each of the business days, a total monetary value of the checks deposited into the safe between the end of day of a business day preceding the respective business day and the end of day for the respective business day; and
electronically transmitting, at the end of day of each of the business days, a respective data file identifying the respective calculated total monetary value to enable for the respective crediting of the retailer by a financial institute with the respective calculated total monetary value.

17. The process of claim 16, wherein depositing the collecting checks into at least one safe includes electronically imaging each of the checks deposited into the safe to produce image data; and wherein said at least one data file includes the image data.

18. The process of claim 17, further comprising, during each financial transaction during which a check is collected from a customer by the retailer, displaying on a display disposed in or coupled to the safe an image of the electronically imaged check as represented by the image data; and receiving a verification from a clerk of the retailer indicating that the image on the display is readable.

19. The process of claim 17, further comprising providing to the customer a printed receipt containing a printed image of the electronically imaged check at an end of a financial transaction in which a check is collected from the customer by the retailer.

20. The process of claim 16, further comprising the steps of receiving by a facility, on each of the business days, the respective electronically transmitted data file; and arranging by the facility for the retailer to be credited by the financial institute with the respective calculated total monetary value.

21. The process of claim 16, wherein the checks deposited into the safe over the plurality of business days are not withdrawn from the safe over the plurality of business days.

22. The process of claim 16, further comprising picking up the checks deposited into the safe in accordance with a pickup schedule; and wherein the end of day does not coincide with the pickup schedule.

23. The process of claim 16, wherein each data file identifies the calculated total monetary value broken down by business day, including a total monetary value of checks deposited into the safe between the end of day of the preceding business day through an end of the preceding business day, and a total monetary value of checks deposited into the safe between a beginning of the respective business day and the end of day for the respective business day.

24. The process of claim 23, further comprising the steps of receiving by a facility, on each of the business days, the respective electronically transmitted data file; and arranging by the facility for the retailer to be credited by the financial institute on a business day basis based on the respective calculated total monetary values identified in the respective electronically transmitted data file.

25. The process of claim 24, further comprising the step of providing the retailer with a report identifying amounts of credit provided to the retailer on a business day basis.

26. A process of providing credit to a retailer for collections occurring during financial transactions with the retailer, comprising the steps of:
collecting checks by a retailer at a plurality of retailer locations over a period of time;
depositing the checks collected at each of the retailer locations into safes respectively disposed at the retailer locations;
calculating a respective total monetary value of the checks deposited into the respective safe at each of the retailer locations over the period of time;
electronically transmitting, for each of the retailer locations, a respective data file identifying the respective calculated total monetary value of the checks deposited at each of the retailer locations;
receiving by a facility all of the electronically transmitted data files; and
arranging by the facility for the retailer to be provided by a financial institute with a total credit corresponding to a sum of the calculated total monetary values of the checks deposited into the safes at each of the retailer locations as identified in the received data files.

27. The process of claim 26, wherein arranging by the facility for the retailer to be provided by the financial institute with a total credit occurs before the checks deposited into the safes are physically removed from the safes.

28. The process of claim 26, wherein calculating a respective total monetary value of the checks deposited into the respective safe at each of the retailer locations is carried at a respective designated time for each of the retailer locations, and a designated time for a first of the retailer locations is substantially different from a designated time for a second of the retailer locations.

29. An electronic system, comprising:
a safe disposed at a retailer location, the safe having stored therein a plurality of checks collected by a retailer over a period of time, the safe being adapted to calculate a total monetary value of the checks deposited into the safe over the period of time, and adapted to electronically transmit a data file identifying the calculated total monetary value of the checks deposited into the safe over said period of time to enable for the crediting of the retailer by a financial institute with the calculated total monetary value of the checks deposited into the safe as identified in the data file.

30. The system of claim 29, further comprising an imager associated with the safe for electronically imaging each of the checks deposited into the safe to produce image data; and the data file includes the image data.

31. The system of claim 30, further comprising a display associated with the safe for displaying an image of one of the electronically imaged checks as represented by the image data; and an input device for receiving a verification from a clerk of the retailer indicating that the image on the display is readable.

32. The system of claim 30, further comprising a printer associated with the safe for printing a receipt containing a printed image of one of the electronically imaged checks at an end of a financial transaction in which the respective check was collected from a customer by the retailer.

33. A system for providing credit to a retailer for collections occurring during financial transactions with the retailer, comprising:
a plurality of checks collected by a retailer at a plurality of locations of the retailer;
a plurality of safes, each of the safes disposed at a respective one of the plurality of locations of the retailer, the checks collected at each of the plurality of locations of the retailer being deposited into a corresponding respective one of the plurality of safes, each of the safes being adapted to calculate a respective total monetary value of the checks deposited into the respective safe and adapted to electronically transmit a respective data file identifying the respective calculated total monetary value deposited at each of the retailer locations; and
a facility for receiving all of the electronically transmitted data files, the facility adapted to arrange for the retailer to be provided with a total credit corresponding to a sum of the calculated total monetary values of the checks deposited into the safes at each of the retailer locations as identified in the received data files.
